(19) United States
(12) Patent Application Publication
(10) Pub. No.: US 2011/0023775 A1
(43) Pub. Date: Feb. 3, 2011

(54) APPARATUS FOR ATOMIC LAYER DEPOSITION

(75) Inventors: Geoffrey Nunes, Swarthmore, PA (US); Richard Dale Kinard, Wilmington, DE (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E.I. DU PONT DE NEMOURS AND COMPANY, Wilmington, DE (US)

(21) Appl. No.: 12/550,706

(22) Filed: Aug. 31, 2009

Related U.S. Application Data
(60) Provisional application No. 61/230,336, filed on Jul. 31, 2009.

(51) Int. Cl. B05C 11/00; B05C 13/00

(52) U.S. Cl. 118/58; 118/500

(57) ABSTRACT

An apparatus for atomic layer deposition of a material on a moving substrate comprises a conveying arrangement for moving a substrate along a predetermined planar or curved path of travel and a coating bar having at least one precursor delivery channel. The precursor delivery channel conducts a fluid containing a material to be deposited on a substrate toward the path of travel. When in use, a substrate movable along the path of travel defines a gap between the outlet end of the precursor delivery channel and the substrate. The gap defines an impedance Z_{g} to a flow of fluid from the precursor delivery channel. A flow restrictor is disposed within the precursor delivery channel that presents a predetermined impedance Z_{fc} to the flow therethrough. The restrictor is sized such that the impedance Z_{fc} is at least five (5) times, and more preferably at least fifteen (15) times, the impedance Z_{g}. The impedance Z_{fc} has a friction factor f. The restrictor in the precursor delivery channel is sized such that the impedance Z_{fc} has a friction factor f that is less than 100, and preferably less than 10.

### CLAIM OF PRIORITY

This application claims priority of the following United States Provisional Application, hereby incorporated by reference:

Apparatus For Atomic Layer Deposition, Ser. No. 61/230,336, filed Jul. 31, 2009.

### BACKGROUND OF THE INVENTION

1. Field of the Invention

This invention relates to an apparatus for atomic layer deposition of material(s) on a substrate.

2. Description of the Art

Atomic layer deposition (“ALD”) is a thin film deposition technique that offers extremely precise control over the thickness of a layer of a compound material deposited on a substrate. As the name implies, the film growth in ALD is layer by layer, which allows the deposition of extremely thin, conformal coatings that are also free of grain boundaries and pinholes. Deposition of this coating is typically done through the application of two molecular precursors. The surface of the substrate is exposed to a first precursor (“precursor I”) molecule, which reacts chemically with the surface. This reaction is self-limiting and proceeds until there is a uniform monolayer coating of reacted precursor I covering the surface. The surface is then exposed to a second precursor (“precursor II”), which reacts chemically with the surface coated with precursor I to form the desired compound. As before, the reaction is self limiting, and the result is a completed monolayer coating of reacted precursor II covering the surface, and therefore a completed monolayer of the desired compound material.

The process can then be repeated, exposing the surface first to precursor I and then to precursor II, until a coating of the desired thickness has been formed. Since each completed I-II layer has a thickness on the order of 0.1 nm, very thin layers, with a very precisely controlled thickness are possible.

Historically, ALD has been carried out by placing the substrate to be coated in a vacuum chamber and introducing a low pressure carrier gas containing some small percentage of precursor, also in the gas phase. However, because the time to completely purge the precursors from the deposition chamber can be long, ALD has typically been regarded as a slow process.

An alternative form of ALD coating head is known that allows deposition at much higher rates. In this head arrangement the precursor gases (again, precursor molecules in an inert carrier gas) are delivered by long narrow channels, and these channels alternate with vacuum uptake channels and purge gas channels. The head is then traversed across the substrate to be coated in a direction perpendicular to the long axis of the output channels (or alternatively held in one position while the substrate is translated underneath it). U.S. Published Patent Application 2008/166,880 (Levy) is representative of the structure of such a head.

The head disclosed in this referenced published application requires that the separation between the head and the substrate be very small (˜ thirty microns) and very closely controlled. In fact, jets of gas emanating from the face of the device are used as a means to float the coating head, in a manner analogous to a hovercraft, over the substrate to be coated.

It view of the foregoing it is believed to be advantageous to provide an apparatus for ALD coating of a substrate that is not sensitive to the precise distance between the coating head and the substrate, but is, instead, independent of the separation between the head and the substrate and tolerant of dimensional variations in that separation. In that way, no extraordinary measures would be needed to keep this separation distance fixed. In particular, it is believed to be advantageous not to require the gases exiting the head to do double duty: i.e., the gases are not be required to serve the function of maintaining a fixed separation at the cost of compromising the main function of the device, the deposition of an ALD coating.

### SUMMARY OF THE INVENTION

The present invention is directed to an apparatus for atomic layer deposition of a material on a moving substrate comprising a conveying arrangement for moving a substrate along a predetermined path of travel through the apparatus and a coating bar having at least one precursor delivery channel. The precursor delivery channel is able to conduct a fluid containing a material to be deposited on a substrate toward the path of travel. When in use, a substrate movable along the path of travel defines a gap between the outlet end of the precursor delivery channel and the substrate. The gap defines an impedance Z_{g} to a flow of fluid from the precursor delivery channel.

The apparatus further comprises a flow restrictor disposed within the precursor delivery channel. The flow restrictor presents a predetermined impedance Z_{fc} to the flow in the precursor delivery channel. The restrictor is sized such that the impedance Z_{fc} is at least five (5) times, and more preferably at least fifteen (15) times, the impedance Z_{g}.

The impedance Z_{fc} has a friction factor f. The restrictor in the precursor delivery channel is sized such that the impedance Z_{fc} has a friction factor f that is less than 100, and preferably less than 10.

The coating bar also has first and second inert gas delivery channels respectively disposed on the upstream and downstream sides of the precursor delivery channel.

The outlet end of each inert gas delivery channel also defines a gap between the end of each inert gas flow delivery channel and the substrate. Each gap defines an impedance Z′_{g} to a flow of fluid from each respective inert gas delivery channel. A flow restrictor is disposed within each inert gas delivery channel. Each flow restrictor presents a predetermined impedance Z′_{fc} to the flow in the respective inert gas delivery channel. Each restrictor within each inert gas delivery channel is sized such that the impedance Z′_{fc} is at least five (5) times, and more preferably at least fifteen (15) times, the impedance Z′_{g}. The impedance Z′_{fc} has a friction factor f′. The restrictor in the inert gas delivery channel is sized such that the impedance Z′_{fc} has a friction factor f′ that is less than 100, and preferably less than 10.

The path of travel of the substrate through the apparatus could be a planar or a curved path of travel.

### BRIEF DESCRIPTION OF THE DRAWINGS

The invention will be more fully understood from the following detailed description taken in connection with the accompanying Figures, which form a part of this application and in which:

FIG. 1 is a stylized diagrammatic representation of an apparatus for continuous flow atomic layer deposition of at least one precursor material on a moving substrate, the apparatus incorporating a coating bar in accordance with the present invention;

FIG. 2 is diagrammatic side section view of the basic structural elements of a coating bar in accordance with the present invention;

FIG. 3 is a block diagram of a control system for a coating apparatus having a coating bar in accordance with the present invention;

FIG. 4 is an exploded perspective view of a coating bar in accordance with the present invention adapted to deposit two precursor materials onto a substrate;

FIG. 5 is an isolated perspective view of a structural plate used to assemble the coating bar shown in FIG. 5;

FIG. 6 is an isolated perspective view of a gasket used to assemble the coating bar shown in FIG. 5;

FIGS. 7 through 11 are side section views of an assembled coating bar of FIG. 4 respectively illustrating the flow paths through the bar for the inert (purge) gas (FIG. 7), exhaust (FIG. 8), precursor I (FIG. 9), precursor II (FIG. 10), and a vent seal path (FIG. 11);

FIG. 12 is a diagrammatic representation of an apparatus for continuous flow atomic layer deposition of material(s) on a moving substrate using one or more coating bar(s) of the present invention wherein the path of travel of the substrate through the apparatus is curved;

FIG. 13 shows the region of space constituting the model of Example 1 rendered as the negative of the structure of FIG. 2;

FIG. 14 indicates the status of the model of Example 1 at time t=0.2 s after the start of the calculation;

FIG. 15 shows a the surface concentration of reacted precursor as a function of lateral position on the substrate boundary E of the model of Example 1;

FIG. 16 is a view similar FIG. 14, but indicates the status of the model of Example 2 at time t=0.2 s after the start of the calculation;

FIG. 17 is a view similar FIG. 15, and shows the surface concentration of reacted precursor as a function of lateral position on the substrate boundary E of the model of Example 2.

### DETAILED DESCRIPTION OF THE INVENTION

Throughout the following detailed description similar reference numerals refer to similar elements in all figures of the drawings.

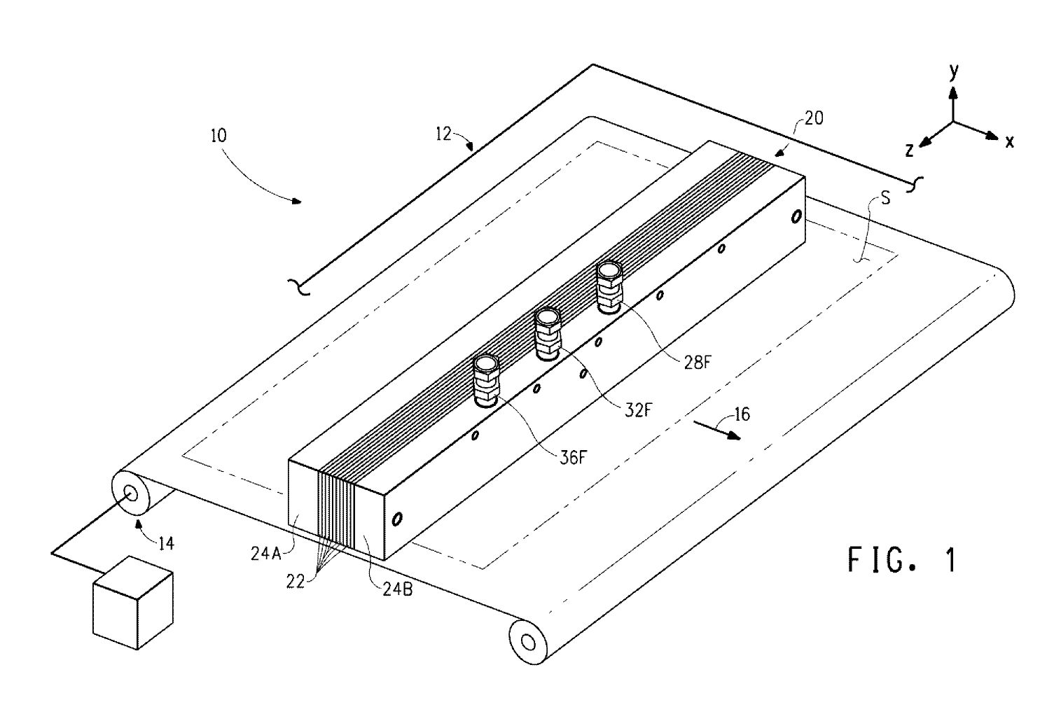

FIG. 1 is a stylized diagrammatic representation of an apparatus generally indicated by the reference character 10 for continuous flow atomic layer deposition of at least one precursor material onto a moving substrate S. The substrate S can be a rigid material, such as a glass plate, or a flexible material, such as a flexible polymer or metallic web. The apparatus 10 includes a suitable enclosure diagrammatically by reference character 12.

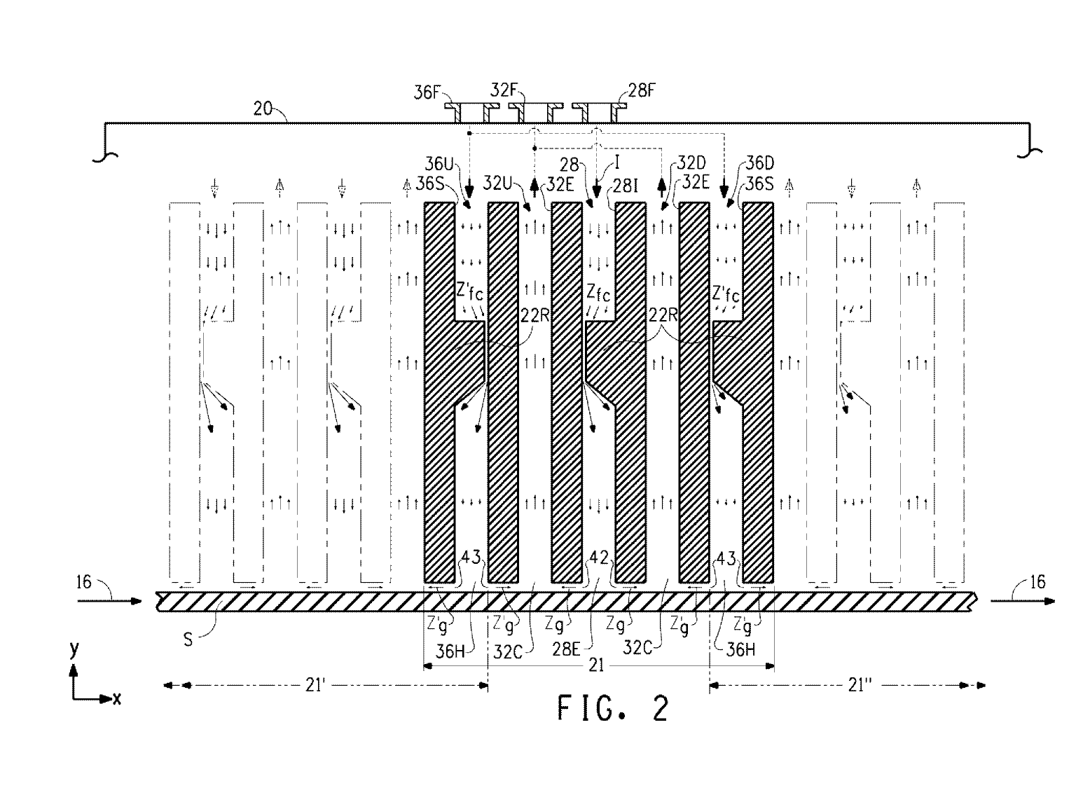

A conveying arrangement 14 is provided within the enclosure 12 for moving the substrate S along a predetermined path of travel 16 through the apparatus 10. In the arrangement illustrated in FIGS. 1 and 2 the substrate S is moved by the conveying arrangement 14 along the positive X-axis of the reference coordinate system indicated in the drawing. The path of travel 16 of the substrate S is generally planar, lying substantially in the X-Z reference plane. The purpose of the enclosure 12 is to contain an inert atmosphere and to allow operation of the apparatus at elevated temperatures.

The apparatus 10 incorporates at least one coating bar 20 in accordance with the present invention. FIG. 2 is a diagrammatic side section view of the basic structural elements of a coating bar 20 from which an understanding of the operation of the bar 20 may be obtained.

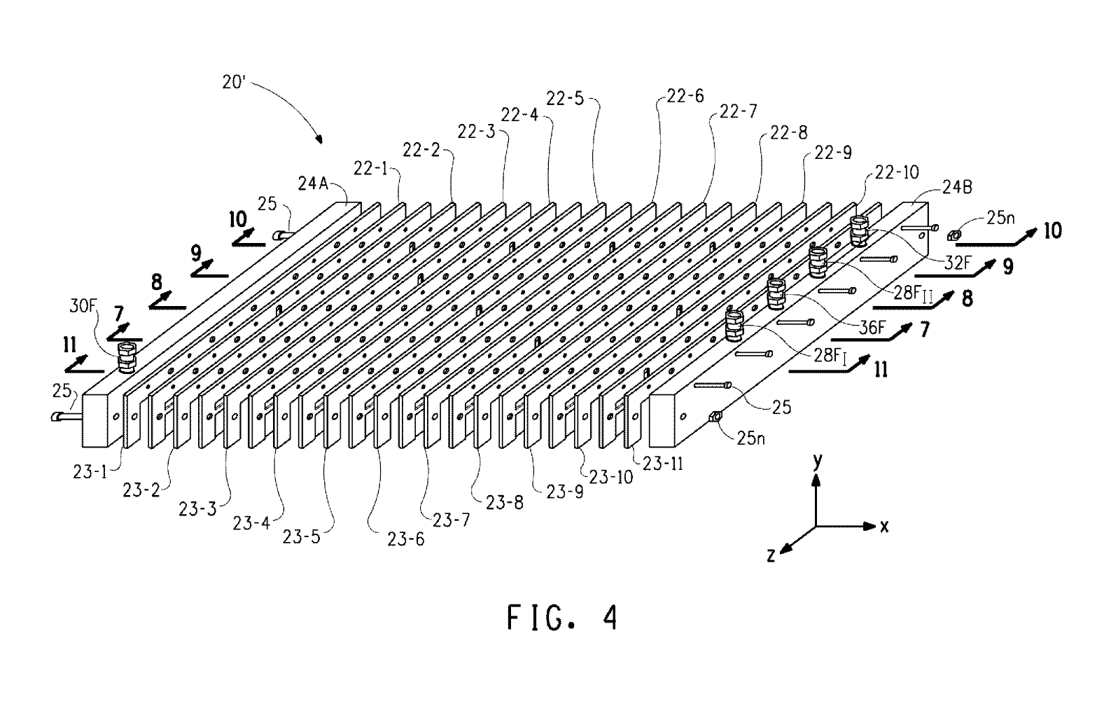

As illustrated in FIGS. 1 and 2 the bar 20 is a generally rectanguloid member configured to provide the various internal fluid delivery and removal channels whereby at least one precursor material is able to be deposited onto the surface of the substrate S as the substrate S is conveyed along the path of travel 16 through the apparatus 10. The set of the various fluid delivery and removal channels necessary to deposit at least one precursor material are grouped together as a precursor deposition module 21 illustrated in solid lines in FIG. 2. As suggested by phantom lines in FIG. 2 and as will be developed in connection with FIG. 4, multiple precursor deposition modules (depicted for example by the reference characters 21′, 21″) may be included in a bar 20′ (FIG. 4) so that a given bar is able to deposit two or more precursors on a substrate being transported beneath the bar.

There is an advantageous efficiency in combining multiple deposition modules (e.g., modules 21, 21″, FIG. 2) into a single coating bar. If a first module 21 containing a precursor delivery channel 28, a pair of exhaust channels 32U and 32D, and a pair of inert gas purge channels 36U and 36D, is juxtaposed next to a second, identical module 21″, then the downstream purge channel 36D of the first module 21 may also serve as the upstream purge channel 36U of the second module 21″. In that way, if a coating bar contains N number of deposition modules 21, it need only contain a total of (N+1) number of purge channels 36.

Structurally, the precursor deposition module 21 within the bar 20 can be constructed in any convenient manner. For example, in the embodiments depicted in this application the precursor deposition module 21 is formed as a layered stack of structural plates 22 bolted between end members 24A, 24B. As will be discussed in more detail each of the plates 22 is configured such that when the sandwich is assembled the space between adjacent plates 22 defines the various internal channels to be explained herein. In addition, the plates have appropriately positioned openings that cooperate to define the necessary supply headers and fluid transport passages within the bar 20.

In its most basic form a precursor deposition module 21 able to deposit a single precursor on a substrate is configured to include a precursor delivery channel 28, a pair of exhaust channels 32, and a pair of inert gas channels 36. Flow arrows depict the direction of the fluid flow in each of the channels to be described. The precursor delivery channel 28, each of the exhaust channels 32, and the inert gas channels all have a predetermined width dimension (measured in the X-direction) on the order of 0.5 to two (2) millimeters, and typically approximately one (1) millimeter.

The precursor delivery channel 28 has an inlet end 28I and an outlet end 28E. As shown by the flow arrows the precursor delivery channel 28 conducts a flow of a fluid containing a precursor material (“I”) supplied at the inlet end 28I of the channel 28 toward the outlet end 28E thereof. The inlet end 28I of the precursor delivery channel 28 is connected to a supply fitting indicated by the reference character 28F. Precursor material carried in the flow exiting from the outlet end 28E of the channel 28 is deposited on the substrate S as the substrate S moves beneath the bar.

An upstream exhaust channel 32U and a downstream exhaust (or “uptake”) channel 32D respectively flank the precursor delivery channel 28 on both its upstream and downstream sides. As generally used herein the terms “upstream” and “downstream” are defined relative to the direction 16 of the substrate S along its path of travel through the apparatus 10 and respectively correspond to negative and positive directions along the reference X-axis. Each exhaust channel 32U, 32D has a collection end 32C and an exhaust end 32E. The collection end 32C of each exhaust channel is adjacent to the path of travel of the substrate S. The exhaust end of each of the exhaust channels 32U, 32D is connected to a common exhaust fitting diagrammatically indicated by the reference character 32F.

The coating bar 20 further includes upstream and downstream inert gas delivery (or “purge”) channels 36U, 36D, respectively. As illustrated, the purge channel 36U is deployed immediately upstream of the upstream exhaust channel 32U, while the purge channel 36D is deployed immediately downstream of the downstream exhaust channel 28D. Each purge channel 36U, 36D serves to deliver an inert fluid, such as nitrogen gas, from a supply end 36S to a discharge end 36H located adjacent to the path of travel of the substrate S. The supply end 36S of each purge channel 36 is connected to a common supply fitting diagrammatically indicated by the reference character 36F.

The outlet end 28E of the precursor delivery channel 28, the collection end 32C of each respective exhaust channel 32U, 32D, as well as the discharge end 36H of each respective purge channel 36U, 36D, all have a transverse dimension (extending the positive Z-direction) that encompasses the entire transverse dimension of the substrate S.

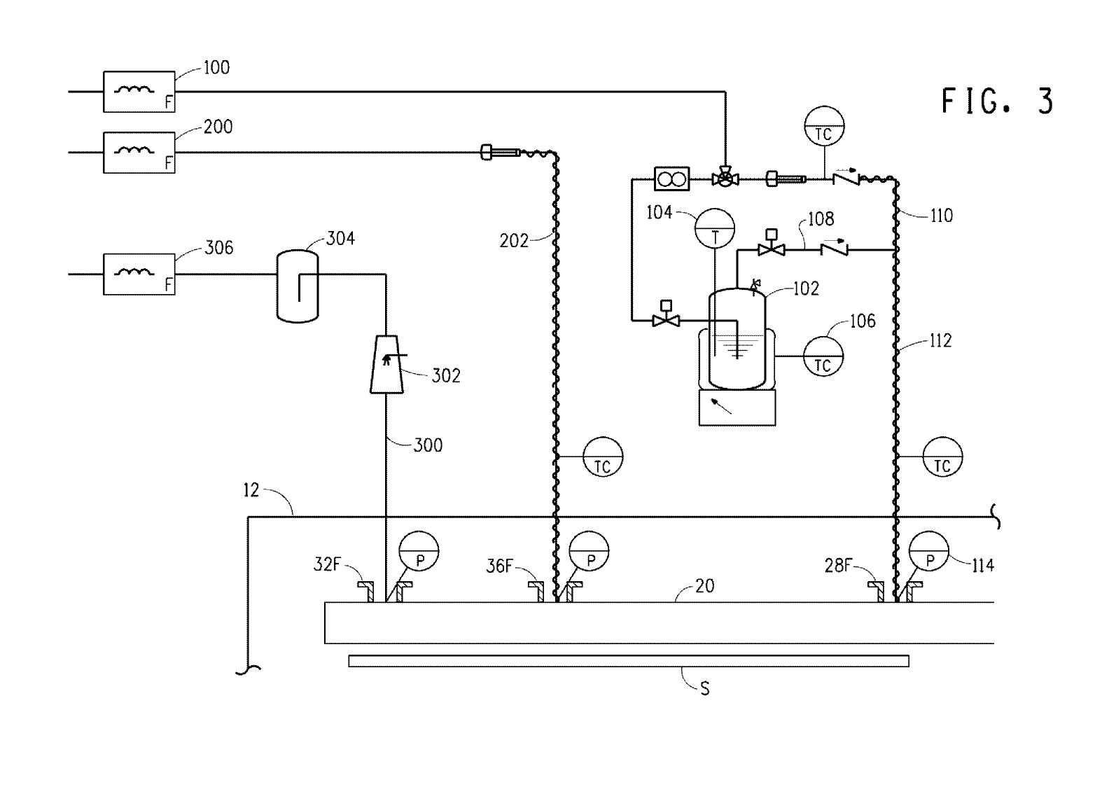

FIG. 3 is a block diagram of the control system for the operation of the apparatus 10. An input flow of nitrogen is provided by the controller 100 and directed to a bubbler 102 containing a precursor material (e.g., material “I”). The temperature of the precursor is monitored via a sensor 104 and controlled via a temperature controller 106. The nitrogen gas, saturated with precursor, exits the bubbler via a line 108 and is optionally combined with a pure nitrogen stream 110. The combined stream, containing precursor at the desired concentration, travels through a temperature controlled line 112 to the precursor inlet connection fitting 28F in the coating bar 20. The pressure of the gas delivered to the coating bar 20 is monitored via a pressure gauge 114. A second input flow of nitrogen is provided by the controller 200 and is delivered to the purge inlet connection fitting 36F of the coating bar 20 via the temperature controlled line 202. A line 300 directs the outflow from the exhaust connection fitting 32F on the coating bar 20 to a spray box 302 and subsequently to a cold trap 304. The rate at which exhaust gas drawn from the apparatus is regulated by the vacuum flow controller 306.

In operation, a gas containing a precursor material (material “I”) is supplied via the fitting 28F to the precursor delivery channel 28. The precursor material is conducted through the precursor delivery channel 28 toward the outlet end 28E thereof. At the outlet end 28E the flow of precursor gas exits the precursor delivery channel 28 and is drawn into a gap 42 defined between the edges of the plates 22 forming the delivery channel 28 and the substrate S. The gap 42 defines an impedance Z_{g} to a flow of fluid from the precursor delivery channel. The magnitude of the impedance Z_{g} is directly controlled by the size of the gap 42.

Simultaneously, a flow of inert gas is introduced via the supply fitting 36F into each of the purge channels 36U, 36D. Each of these flows is conducted toward the respective discharge end 36D of these channels. The inert gas flows are similarly drawn into gaps 43 defined between the edge of the plates 22 forming these channels and the substrate S. These gaps 43 similarly define an impedance Z′_{g} to a flow of fluid from the inert gas delivery channels. The size of the gap 43 directly controls the magnitude of the impedance Z′_{g}.

The precursor gas flow as well as the inert gas flows are drawn toward and collected by the collection ends 32C of the exhaust channels 32U, 32D. As the precursor flow squeezes through the gap 42 a layer of precursor “I” material is deposited on the substrate S.

As noted in connection with the discussion of a known ALD coating head as set forth in the Background portion of the application, the dimension of the gaps between the coating head and the substrate S must be rigorously controlled to insure that these dimensions remain relatively constant, since small changes in the dimension of a gap results in large changes in the flow. However, a coating bar in accordance with the present invention is able to maintain a substantially steady (i.e., variable but within tolerable process limits) flow of precursor material toward the substrate even if the dimension of the gap(s) 42 and/or 43 change(s).

The elimination of dependence on the gap dimension in accordance with the present invention is obtained by disposing a flow restrictor 22R in the precursor delivery channel 28 as well as in each of the inert gas delivery channels 36U, 36D. The presence of the flow restrictor 22R narrows each of these channels and creates a restriction to the flow of gas therethrough.

The restriction in the precursor delivery channel 28 caused by the restrictor 22R presents a predetermined impedance Z_{fc} to the flow therethrough. In accordance with the present invention the restrictor is sized such that the impedance Z_{fc} is at least five (5) times the impedance Z_{g}. More preferably, the impedance Z_{fc} is at least fifteen (15) times the impedance Z_{g}.

Similarly, the presence of a restriction 48 in each of the inert gas delivery channels 36 presents a predetermined impedance Z′_{fc} to the flow through these channels. The restrictor in each of these channels 36 should also be sized such that the impedance Z′_{fc} is at least five (5) times, and more preferably at least fifteen (15) times, the impedance Z′_{g}.

By appropriately sizing the restriction to exhibit the defined relationship between the flow impedance in the channel with respect to the impedance in the gap at the outlet of the channel the delivery of the precursor and the purge gas, as the case may be, is made independent of the gap impedance made tolerant of variations in the dimension of the gap(s) 42 and/or 43 and therefore substantially of the gap impedances Z_{g} and/or Z′_{g}.

The various impedances Z_{g}, Z′_{g}, Z_{fc} and Z′_{fc} relate the volumetric flow Q through the gap or channel (as the case may be) to the pressure drop ΔP along the path of the fluid according to

$$Q = \frac{Δ P}{Z} . \qquad ( 1 )$$

Flow impedance is discussed in S. Dushman, The Scientific Foundations of Vacuum Technique, 2 Ed., John Wiley & Sons, New York, 1962.

The impedances Z_{fc} and/or Z′_{fc} relate can also have friction factors f and f′, respectively. Such friction factors f, f′ relate the shear stress at the wall of a restriction τ_{w} to the kinetic energy K of the moving fluid according to

τ_{w}=fK (2).

The friction factor is discussed in F. A. Holland and R Bragg, Fluid Flow for Chemical Engineers, Elsevier, Amsterdam, 1995.

In accordance with the present invention the impedance Z_{fc} in the precursor delivery channel has a friction factor less than 100, and more preferably less than 10. In addition, in accordance with the invention the impedance Z′_{fc} in each inert gas delivery channel has a friction factor less than 100, and more preferably less than 10.

The flow restrictor 22R may take any convenient form. In the arrangement illustrated the flow restrictor takes the form of a rectanguloid projection that extends transversely across either one (or both) of the plates defining the particular delivery channel. In the preferred case the restrictor defines a flow restriction that extends the full transverse (Z direction of the bar). Preferably the flow restrictor should include a transition surface 22C at the end of the restriction to minimize the formation of eddies in gas flow through the channel. The transition surface 22C may be planar, as illustrated. However, the shape of the surface may be otherwise configured.

As noted earlier, a coating bar may contain multiple precursor deposition modules 21. FIG. 4 is an exploded perspective view of a coating bar 20′ adapted to deposit two precursor materials (material “I” and material “II”) on a substrate. In the particular construction illustrated the coating bar 20′ is formed as a layered assembly comprising ten (10) structural plates 22 alternated between eleven (11) gaskets 23. The layered assembly is closed by end bar 24A, 24B secured by bolts 25 and nuts 25N.

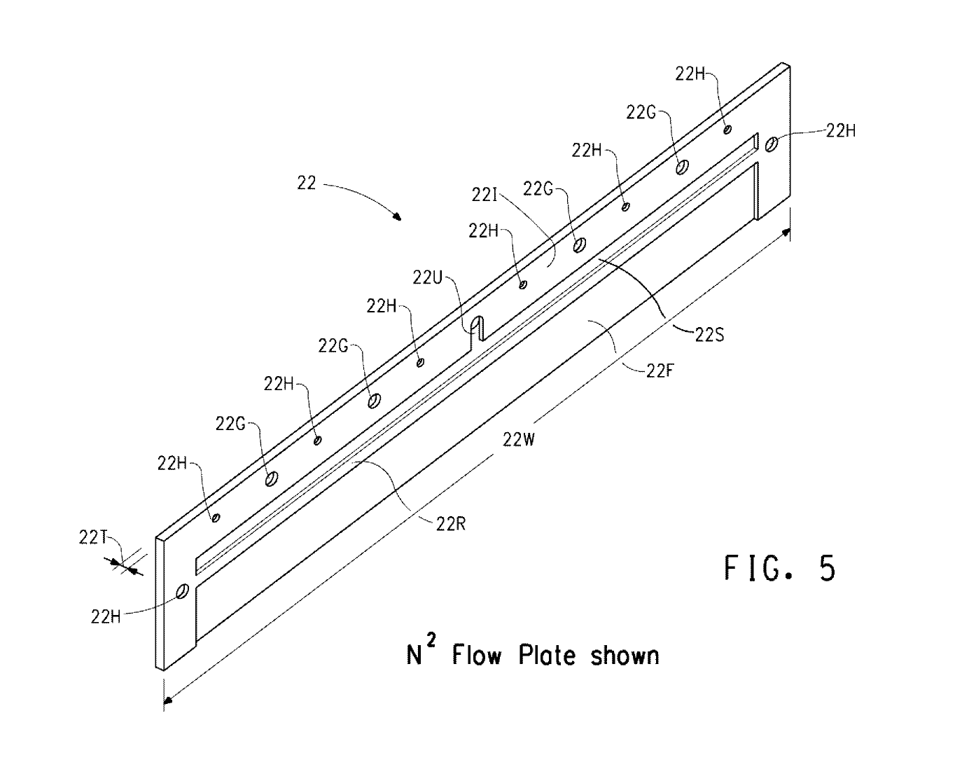

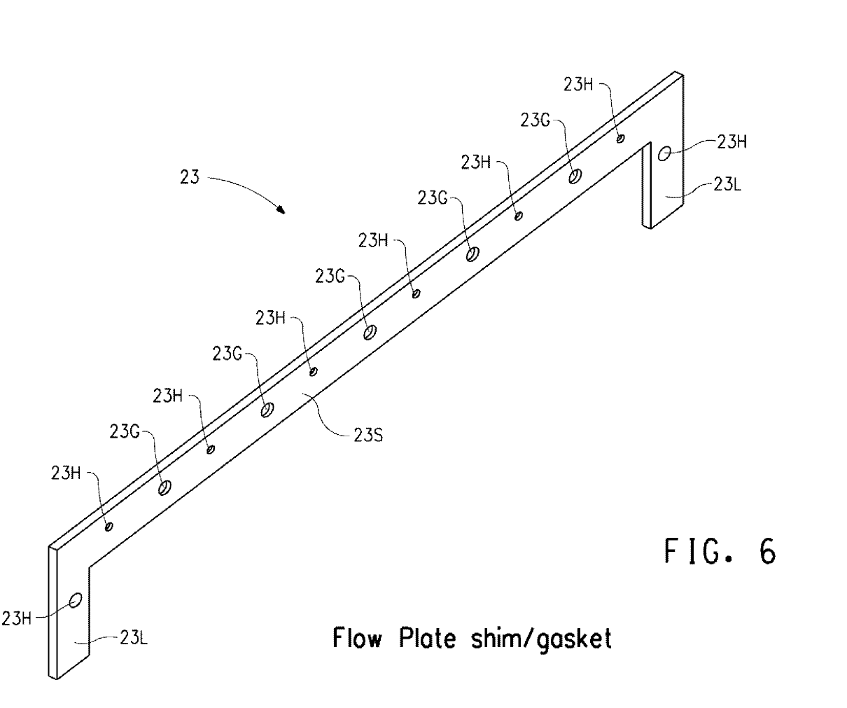

FIG. 5 is an isolated perspective view of an individual plate 22 while FIG. 6 shows an isolated perspective view of an individual gasket 23.

As seen from FIG. 5 each structural plate 22 is a generally planar member fabricated from any suitably rigid material compatible with the gases and temperatures associated with the ALD process. The plates are typically one to two millimeters (1-2 mm) in thickness. Each plate 22 has a header region 22I which exhibits the full thickness 22T of the plate. A full-thickness rectanguloid bar 22R extends across the full transverse dimension 22W of the plate 22. Portions of one surface of each plate 22 above and below the restrictor bar 22R are relieved defining a transversely extending supply slot region 22S and a relatively enlarged flow region 22F. Appropriately positioned through openings 22G and holes 22H are provided in the header region 22H of the plate. A furrow 22U defines a transport passage that connects one of the openings in each plate 22 with the supply slot region 22S therein.

As seen in FIG. 6 an individual gasket 23 is a generally C-shaped member fabricated from a suitable polymer material. Each gasket has a transversely extending spacer portion 23S having appropriately positioned through openings 23G and holes 23H therein. Legs 23L depend from each end of the spacer portion 23S.

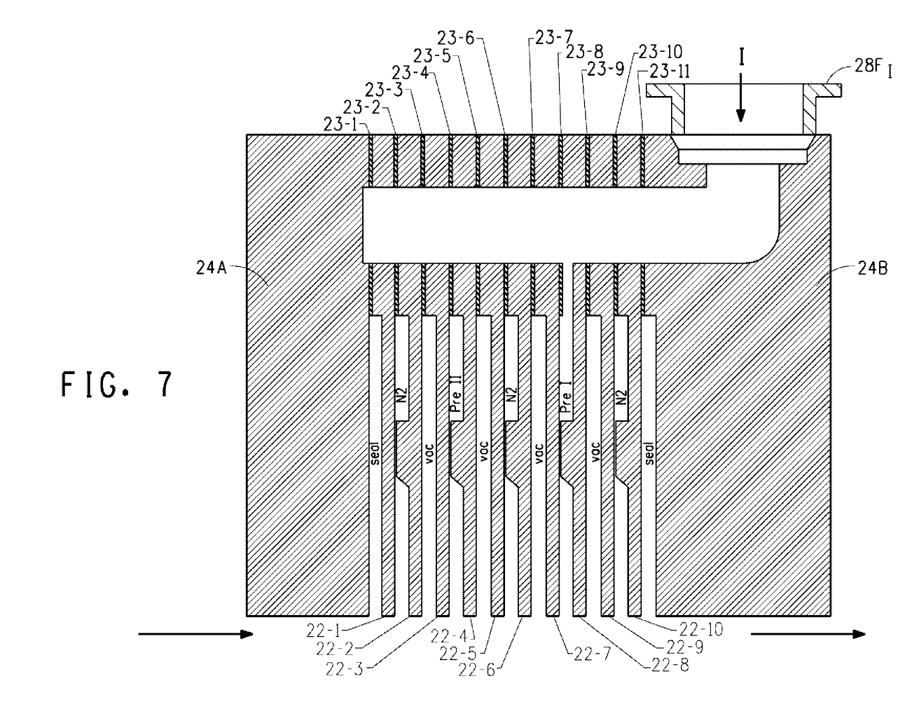

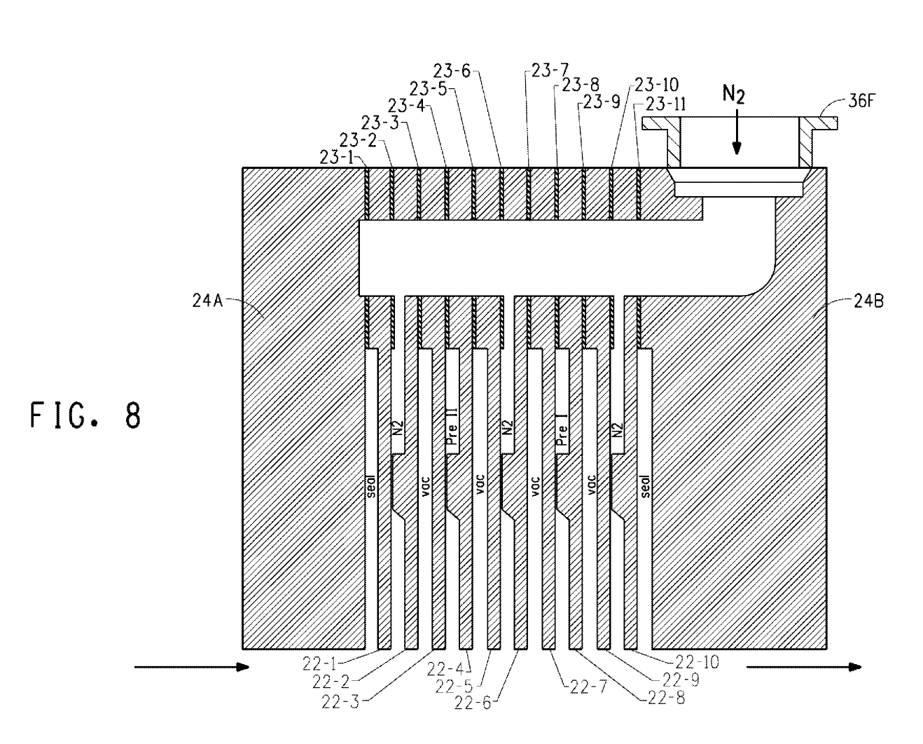

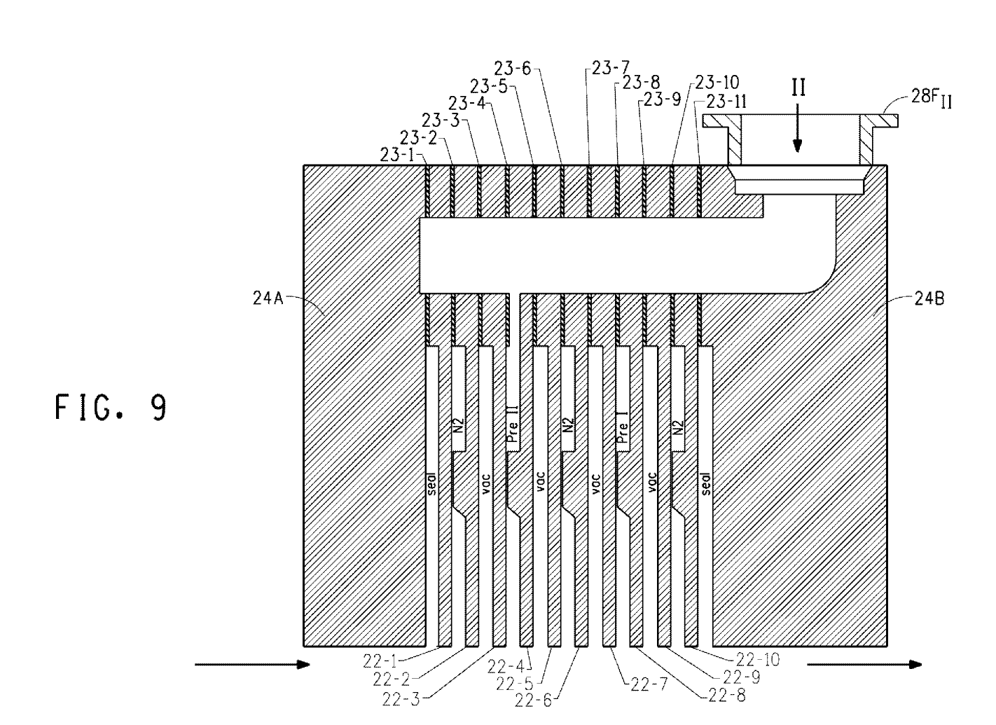

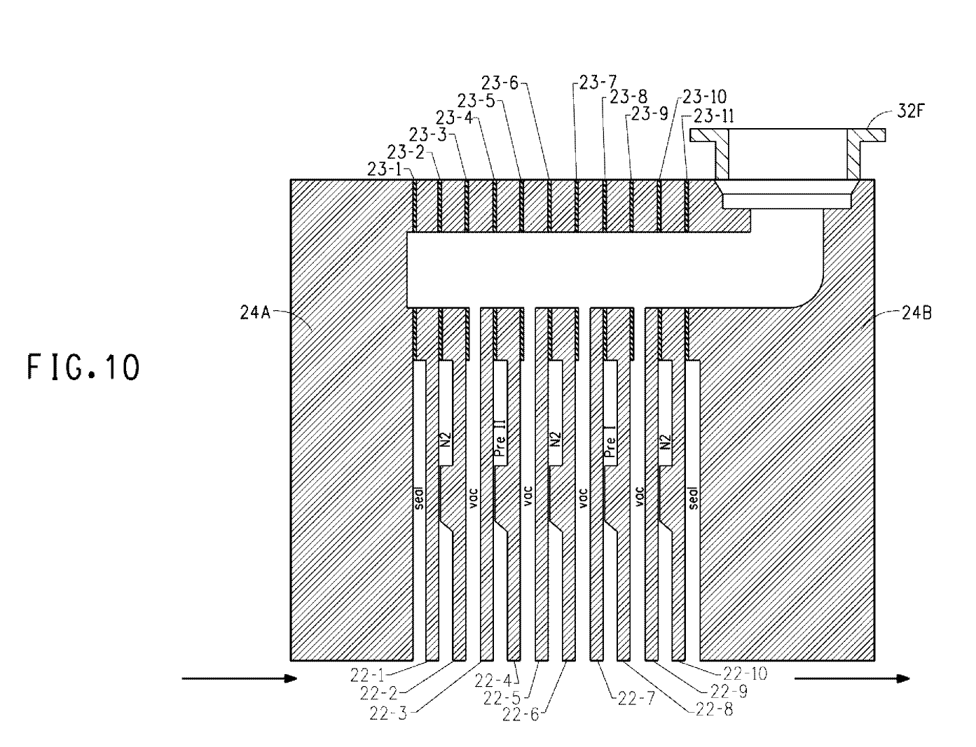

As shown from the exploded view of FIG. 4 and the section views of FIGS. 7-11 delivery modules 21, 21′ for each of two precursors (material “I” and material “II”, respectively) are formed by stacking ten (10) structural plates 22-1 through 22-10 alternated intermediately between eleven gaskets 23-1 through 23-11.

As is apparent from FIG. 4 when the layered stack is so formed the holes 22H, 23H in each of the plates 22 and gaskets 23 register to define holes that receive bolts 25 thereby to the secure the stack to the end bars 24A, 24B.

Appropriate ones of the through openings 22G, 23G in the plates 22 and gaskets 23 respectively register with each other to define supply headers that extend appropriate predetermined distances into the bar 20′. The supply headers communicate with fittings provided on one of the ends bars 24A, 24B.

The relieved supply slot region 22S and enlarged flow region 22F in one surface of each plate confronts the opposed surface of the adjacent plate to define the various delivery and exhaust channels present in the bar 20′. The furrow 22U in each plate connects the supply slot in that plate to the appropriate passage formed in the bar. The presence of a gasket 23 intermediate between adjacent plates 22 serves to space the restrictor bar 22R on the surface of one plate away from the opposite surface of the adjacent plate, thereby defining the restriction in each channel. The impedances and friction factor of a restrictor 22R may be determined from a measurement of both the pressure drop across the restriction and the mass flow through it, the equipment and methods necessary for such a measurement being well known. The value of the impedance of a restrictor 22R may be adjusted by changing the thickness of the associated gasket 23.

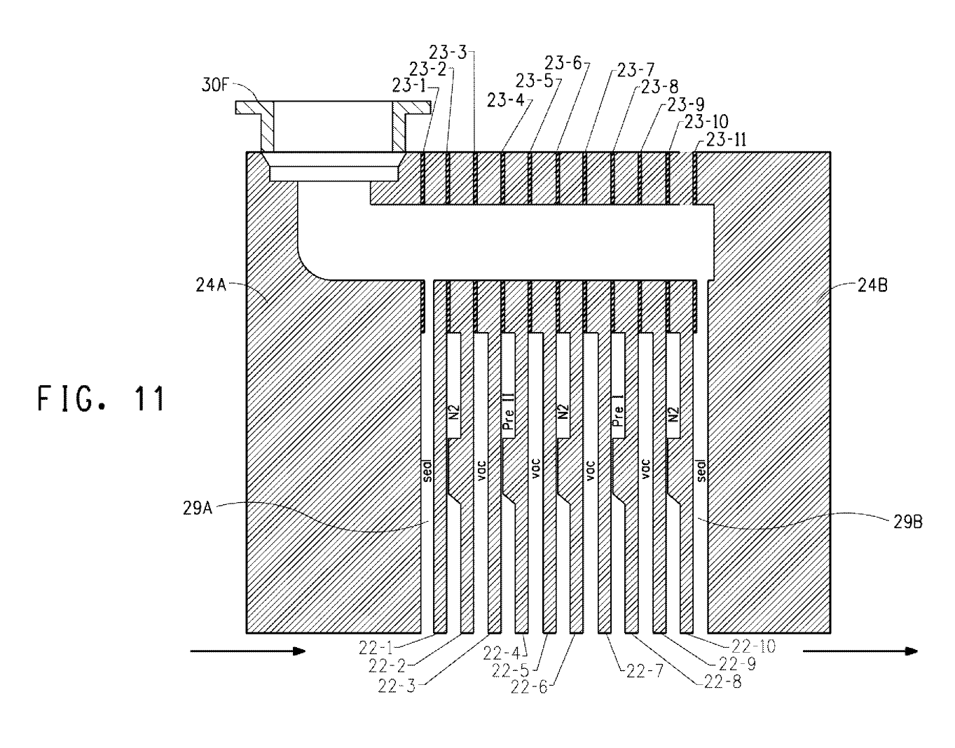

FIG. 11 illustrates additional exhaust channels 29A, 29B that are disposed adjacent the end bars 24A, 24B, respectively. These additional exhaust channels 29A, 29B serve to scavenge any residual precursor gases from the gap between the coating bar 20′ and the substrate S and convey them to a discharge fitting 30F.

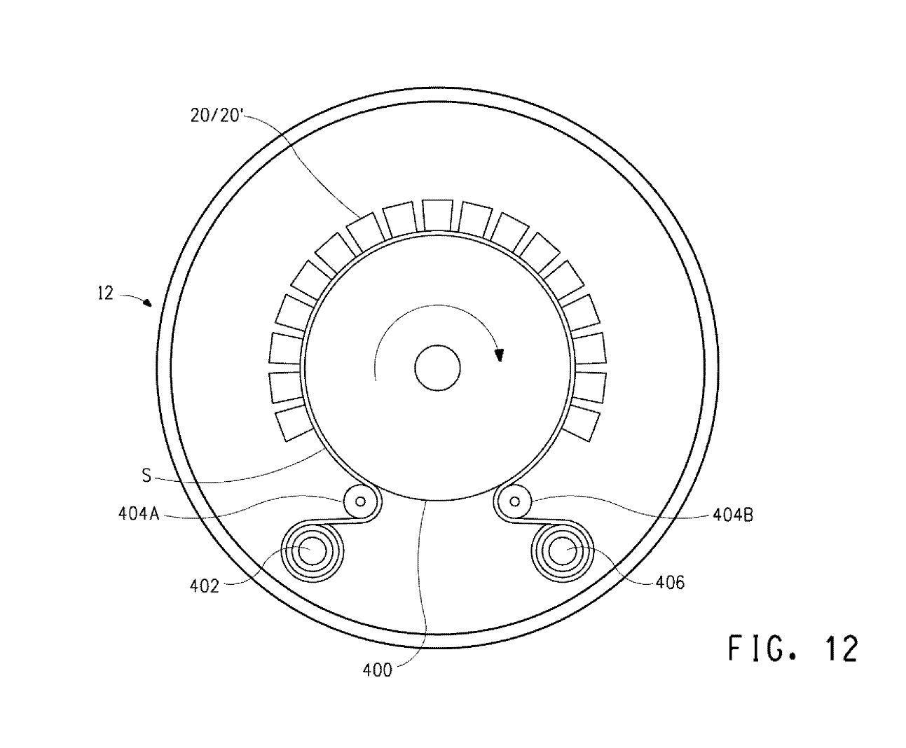

Since the delivery of precursor material is independent of the gap dimension, the path of travel of the substrate the can be curved. FIG. 12 is a stylized diagrammatic view of a ALD apparatus in which a substrate S is carried by a circular drum 400 along a curved path from an input roll 402, over idler rolls 404A, 404B, to an output roll 406. The path takes the form of the Greek symbol “Omega”. As seen, one or more bars 20, 20′ can be disposed along the path of travel.

If the radius of curvature of the curved path is sufficiently large, and/or if the individual coating bars are sufficiently narrow, the output face of the coating bar whereby the precursor and purge gases emerge need not be shaped to match the curve. If, however, such is not the case, the individual plates 22 may be shaped such that the gaps 42 and 43 remain constant across the output face of the bar without adversely impacting the performance of the apparatus.

### EXAMPLES

The operation of an atomic layer deposition apparatus having a coating bar in accordance with the present invention may be understood more clearly from the following Examples.

### Example 1

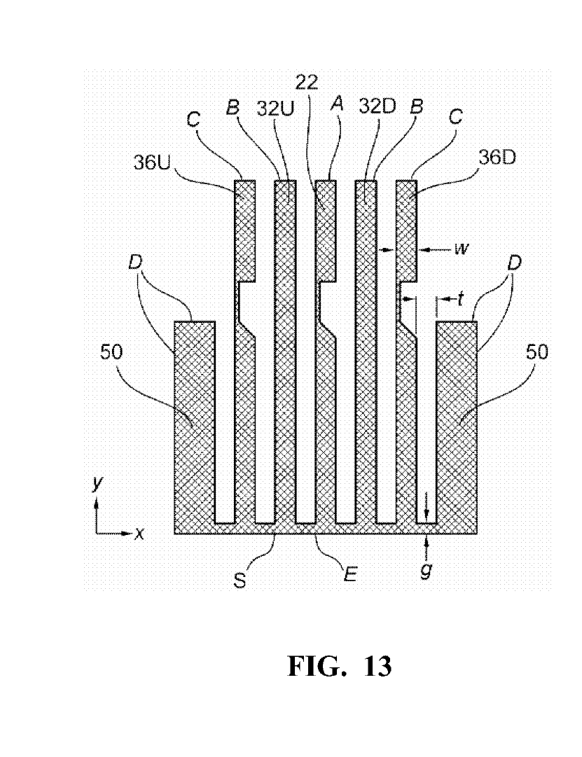

A coating bar capable of depositing a single precursor layer according to the embodiment of FIGS. 1 and 2 was investigated using a finite element numerical model. The boundaries of this model were largely defined by the plates which comprise the coating bar, and by the substrate. For that reason FIG. 13, which shows the region of space constituting the model, is rendered as the negative of FIG. 2.

This model included a single precursor delivery channel (28) flanked by a pair of exhaust channels (32U, 32D). The exhaust channels were flanked by a pair of inert gas channels (36U, 36D). The gap (42) was defined between a flat substrate S and the end of the precursor delivery channel. Finally, the module was flanked with a pair of wider regions (50, FIG. 13) to correspond with the disposition of the coating bar in a surrounding atmosphere of inert gas.

The vertically disposed fluid delivery and uptake channels had a width w=1 mm, except in the region of the flow restrictions. The channels were separated by solid plates of thickness t=1 mm. The substrate surface, designated E, was disposed a distance g=0.1 mm below the output face of the bar.

The open volume in the model was considered to be filled with a fluid having the properties of nitrogen gas at a temperature of 373 K. This gas was considered to be an Incompressible Navier-Stokes fluid and, in the bulk, to obey the equations:

ρ(\vec{u}·\vec{∇})\vec{u}=\vec{Δ}·[pI+μ(\vec{∇}\vec{u}+(\vec{∇}\vec{u})^{T})], (E1.1a)

\vec{∇}·\vec{u}=0, (E1.1b)

where ρ is the fluid density, \vec{u} is the fluid velocity, and μ is the fluid viscosity. I is the identity tensor. In order to solve any system of equations within a defined region, the behavior on the boundaries that define the region must be specified. In FIG. 13, the heavy line surrounding the shaded area constitutes the boundary to the modeled region. Certain segments of these boundaries are denoted by the letters A through E, as these boundaries require specifications different from those of the unlabeled sections. The boundaries indicated by the letters A through D on FIG. 13 represent inlets and outlets where fluid could pass into or out of the model. Boundary A was the precursor inlet (corresponding to the inlet end 28I of the channel 28), the boundaries B were the fluid uptakes (corresponding to the exhaust ends 32E of the channels 32U, 32D), and the boundaries C were the purge inlets (corresponding to the supply ends 36S of the channels 36U, 36D). The external boundaries D of the wider regions 50 represent the divide between regions of the atmosphere around the module that were modeled, and regions that were not.

Along these boundaries, the conditions on the fluid entering or leaving the modeled region were given by

μ(\vec{∇}\vec{u}+(\vec{∇}\vec{u})^{T})\hat{n}=0, (E1.2a)

p=constant, (E1.2b)

where \hat{n} is an inward pointing unit vector normal to the boundary. Along each indicated boundary, the pressure was held constant at the value given in Table E1.1.

TABLE E1.1

| Boundary | Pressure (Pa) |
|---|---|
| A | 101000 |
| B | 100500 |
| C | 99975 |
| D | 100000 |

All of the remaining boundaries with the exception of E (i.e. all the unlabeled boundaries), represented physical walls where the well known “no slip” boundary condition, \vec{u}=0, was applied. The last boundary, indicated as E, represented the substrate. Here also the no slip condition was applied: the velocity of the fluid with respect to the substrate was taken as zero at the line of contact, but the substrate itself was in motion with speed v₀ directed in the positive x direction, so that the calculated fluid flow would be correct for a coating bar in close proximity to a moving substrate.

Transport of the precursor within the fluid was calculated according to the convection and diffusion equation,

$$\frac{\partial c}{\partial t} + \vec{∇} \cdot ( - {D}_{12} \vec{∇} c ) - \vec{u} \cdot \vec{∇} c = 0 , \qquad ( E 1.3 )$$

where c is the molar concentration of precursor dispersed in the inert carrier gas, and the fluid velocity is given by the solution to Eq. E1.1, with the boundary conditions discussed. D₁₂ is the diffusion coefficient for the precursor in the carrier gas. This quantity was taken as

$${D}_{12} = \frac{{D}^{*}}{P} , \qquad ( E1 .4 )$$

with a value for D*, calculated according to J. C. Slattery and R. B. Bird (A. I. Ch. E. Journal vol. 4, p. 137, 1958) for a trimethylaluminum precursor in a nitrogen carrier gas, of 1.2 Pa-m²/s.

The boundary condition for Equation E1.3 along all unlabeled boundaries in FIG. 13 was

\hat{n}·(−D₁₂\vec{∇}c+c\vec{u})=0, (E1.5)

which specifies that no precursor may be carried through these boundaries. The condition along boundary A was taken as

\hat{n}·(−D₁₂\vec{∇}c+c\vec{u})=c₀u_{y}(x), (E1.6)

representing an inward flux of precursor at a concentration c₀ of 1 molar %. Along B, C, and D, the boundary condition was taken as

\hat{n}·(−D₁₂\vec{∇}c)=0. (E1.7)

This so called convective flux condition allowed precursor to be carried in or out across the boundary as the local values for the concentration and the fluid velocity indicated. Finally, along E, the boundary condition was taken as

\hat{n}·(−D₁₂\vec{∇}c+c\vec{u})=−kₛσc(θ₀−cₛ), (E1.8)

where cₛ is the surface concentration (mol/m²) of precursor already chemically bound to the substrate, θ₀ is the surface concentration of a completed monolayer of precursor, σ is the probability that a precursor molecule striking the surface will react and bind rather than deadsorbing, and kₛ is the surface rate constant.

The rate constant was calculated from elementary kinetic theory (F. Reif, Fundamentals of Statistical and Thermal Physics, McGraw-Hill, New York, 1965) to be kₛ=2.27×10⁶ m³ mol⁻¹ s⁻¹. The sticking probability was taken as (C. Soto and W. T. Tysoe, J. Vac. Sci. Technol. A, vol. 9, p. 2686, 1991) σ=0.01, and θ₀ was calculated from the known density of ALD deposited Al₂O₃ films (Groner et al., Chem. Mater. vol. 16, p. 639, 2004) to be 2.66×10⁻⁵ mol/m². Eq. E1.7 therefore gives a flux of precursor leaving the gas phase to deposit on to the substrate.

On the substrate surface, the concentration of deposited precursor was given by the solution to the equation

$$\frac{\partial {c}_{s}}{\partial t} = - {v}_{0} \frac{\partial {c}_{s}}{\partial x} + {k}_{s} σ c ( {θ}_{0} - {c}_{s} ) , \qquad ( E1 .9 )$$

with the point boundary conditions

$$\frac{\partial {c}_{s}}{\partial t} = 0 \qquad ( E 1.10 )$$

at x=0 (the left-hand end of boundary E in FIG. 13), and

$$\frac{\partial {c}_{s}}{\partial t} = - {v}_{0} {c}_{s} \qquad ( E1 .11 )$$

at x=15 mm (the right-and end of boundary E in FIG. 13 E1.1).

For the purposes of computational efficiency, the system of equations was solved in a two step process. First the Navier-Stokes component only was solved as a stationary problem, then the full coupled system of equations was solved as a transient problem. The initial conditions for the fluid flow in the transient problem were taken from the solution to the stationary problem. The initial condition for the convection-diffusion component was c=0 everywhere. The initial condition for the deposited precursor was cₛ=0 all along boundary E.

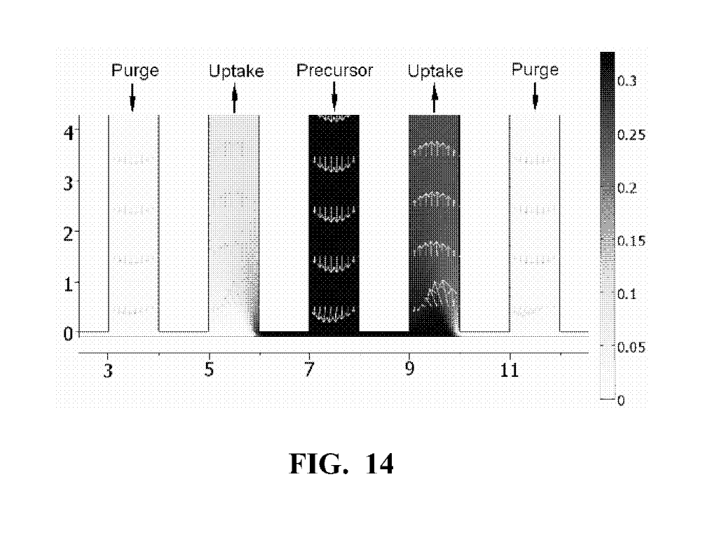

FIG. 14 E1.2 indicates the status of the model at time t=0.2 s after the start of the calculation (in model time, not computation time). The concentration of precursor in the fluid as gray scale. The vertical and lateral positions within the model are given in mm, and the concentration is given in mol/m³. In addition, the local direction and relative magnitude of the fluid velocity is indicated with arrows for some locations. At this point in time the concentration profile was stable, having reached a steady state at about t=0.14 s. It is apparent from the FIG. 14 that the precursor concentration is zero in the region of the purge channels, the combination of the purges and the fluid uptakes acting to completely confine the precursor to the central region of the model.

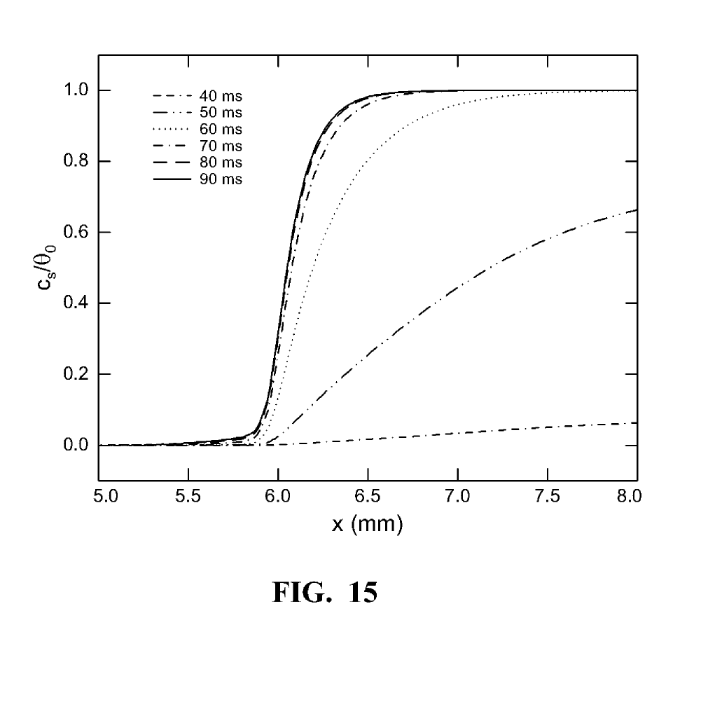

FIG. 15 shows the surface concentration of reacted precursor as a function of lateral position on the substrate boundary E. The concentration profile is shown at several different times, as indicated by the legend. For later times, the profile is indistinguishable from the profile at t=90 ms. The data are normalized by the maximum concentration, so maximally covered surface is represented by a value of 1. A particular spot on the moving substrate passes under the upstream edge of the bar at x=2 mm with a surface concentration cₛ=0. As this spot progresses from x=5 mm to x=7 mm, it rapidly becomes covered with precursor, and exits from under the bar at x=13 mm with a saturated coating.

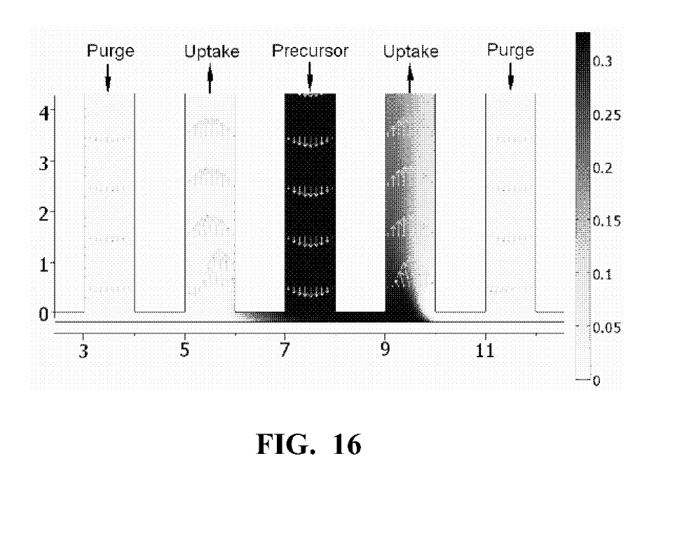

Example 2 The coating bar of Example 1 was analyzed in the case that the substrate was disposed a distance g=0.2 mm below the output face of the bar. All other particulars of the analysis remain the same as in Example 1. FIG. 16 shows the same view as FIG. 14, but for the case of Example 2. There are minor differences in the concentration profile and fluid flow, as compared to Example 1, but the essential particular, the confinement of the precursor to the central region of the model, remains unaffected.

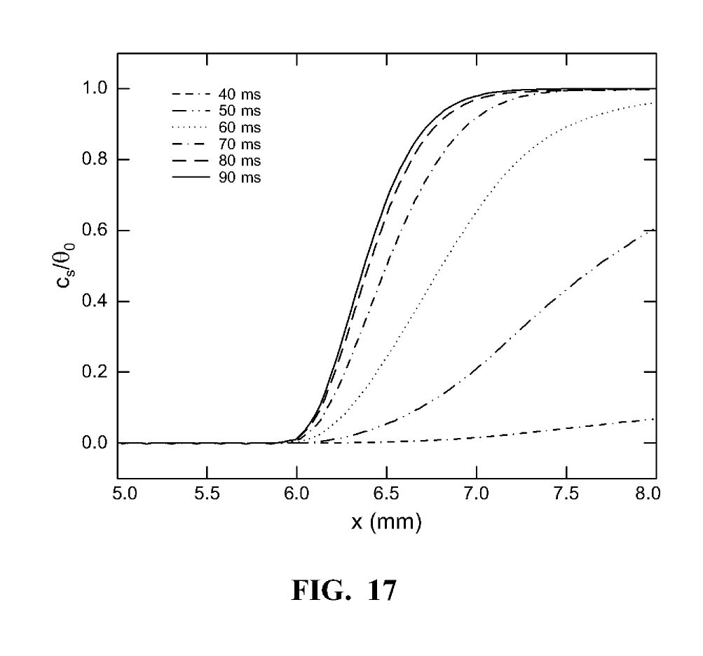

FIG. 17 shows the same view as FIG. 14, but for the case of Example 2. As in the previous example, a steady state coating profile has been achieved by t=90 ms. Full coverage is obtained. The main difference with Example 1 is that the region in which the coating takes place has shifted a fraction of a millimeter in the downstream direction.

Taken together these examples show that the deposition as performed by an apparatus having the impedances having the relations as defined herein and friction factors in the ranges as defined herein is insensitive to moderate variations in the separation between the coating bar and the substrate. The variation in g from Example 1 to Example 2 is of a size that might reasonably be expected in a mechanical apparatus containing moving or translating parts. For example, if the substrate was held to a rotating drum, as in FIG. 12, g might vary by 0.1 mm due to a lack of perfect concentricity in the drum or its mounting.

Those skilled in the art, having the benefit of the teachings of the present invention as hereinabove set forth may effect numerous modifications thereto. Such modifications are to be construed as lying within the contemplation of the present invention as defined by the appended claims.

What is claimed is:

1. Apparatus for atomic layer deposition of a material on a moving substrate, the apparatus comprising:
a conveying arrangement for moving a substrate along a predetermined path of travel through the apparatus;
a coating bar having at least one precursor delivery channel defined therein, the precursor delivery channel having an outlet end, the precursor delivery channel being able to conduct a fluid containing a material to be deposited on a substrate toward the path of travel;
so that, when in use, a substrate movable along the path of travel defines a gap between the outlet end of the precursor delivery channel and the substrate, the gap defining an impedance Z_{g} to a flow of fluid from the precursor delivery channel,
a flow restrictor disposed within the precursor delivery channel, the flow restrictor presenting a predetermined impedance Z_{fc} to the flow in the precursor delivery channel,
the flow through the impedance Z_{fc} having a friction factor f,
wherein the restrictor is sized such that the impedance Z_{fc} is at least five (5) times the impedance Z_{g} and
the friction factor f is less than 100.

2. The apparatus of claim 1 wherein the precursor delivery channel has an upstream and a downstream side relative to the path of travel of a substrate through the apparatus, and wherein
the coating bar has first and second inert gas delivery channels defined therein, the first and second inert gas delivery channels being respectively disposed on the upstream and downstream sides of the precursor delivery channel,
each inert gas delivery channel having an outlet end, each inert gas delivery channel being able to conduct an inert fluid toward the path of travel;
so that, when in use, a substrate movable along the path of travel defines a gap between the end of each inert gas delivery channel and the substrate, each gap also defining an impedance Z′_{g} to a flow of fluid from each inert gas delivery channel,
wherein the coating bar further comprises:
a flow restrictor disposed within each inert gas delivery channel, each flow restrictor presenting a predetermined impedance Z′_{fc} to the flow in the respective inert gas delivery channel,
the flow through the impedance Z′_{fc} having a friction factor f′,
each restrictor being sized such that the impedance Z′_{fc} to is at least five (5) times the impedance Z′_{g} and
the friction factor f′ is less than 100.

3. The apparatus of claim 2 wherein the restrictor in the precursor delivery channel is sized such that the impedance Z_{fc} is at least fifteen (15) times the impedance Z_{g}.

4. The apparatus of claim 1 wherein the restrictor in the precursor delivery channel is sized such that the impedance Z_{fc} is at least fifteen (15) times the impedance Z_{g}.

5. The apparatus of claim 3 wherein the restrictor in each inert gas delivery channel is sized such that the impedance Z′_{fc} is at least fifteen (15) times the impedance Z′_{g}.

6. The apparatus of claim 2 wherein the restrictor in each inert gas delivery channel is sized such that the impedance Z_{fc} is at least fifteen (15) times the impedance Z_{g}.

7. The apparatus of claim 1 the friction factor f is less than 10.

8. The apparatus of claim 4 the friction factor f is less than 10.

9. The apparatus of claim 6 the friction factor f′ is less than 10.

10. The apparatus of claim 2 the friction factor f′ is less than 10.

11. The apparatus of claim 1 wherein the path of travel of the substrate through the apparatus is curved.

12. The apparatus of claim 1 wherein the path of travel of the substrate through the apparatus is planar.

13. The apparatus of claim 2 wherein the path of travel of the substrate through the apparatus is curved.

14. The apparatus of claim 2 wherein the path of travel of the substrate through the apparatus is planar.
